(19) United States
(12) Patent Application Publication
(10) Pub. No.: US 2004/0096266 A1
(43) Pub. Date: May 20, 2004

(54) Connecting element for an assembly system

(76) Inventors: Ulrich Birnbaum, Penzing (DE); Adrian Steingruber, Graben (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/638,179

(22) Filed: Aug. 7, 2003

(30) Foreign Application Priority Data
Aug. 8, 2002 (DE) 102 36 552.0

(51) Int. Cl. F16B 9/00

(52) U.S. Cl. 403/187

(57) ABSTRACT

A connecting element configured as a bracket element (1) for an assembly system having system supports comprises two members (2; 3), wherein the members (2; 3) are provided with elongated openings (4, 5). The system support has on its outer walls openings in a predefined spacing. Notches (6, 7) are arranged in the zone of the elongated openings (4, 5); the notches can be brought into engagement with the complementary notches of a fastening element. For fastening of the bracket element (1), a fastening element is passed through the elongated openings (4, 5) and the openings in the outer walls of the system support and the fastening element tensioned. The complementary notches engaging in the notches (6, 7) creates a form-locking connection and makes possible an extensively released positioning of the openings in the outer walls of the support and fixation of the bracket element (1).

### BACKGROUND OF THE INVENTION

The invention relates to a connecting element for an assembly system made up of a plurality of supports, in particular for an assembly system with system supports, wherein the supports have openings, arranged in a predetermined spacing on at least one of the outer walls of the support. The connecting element has a first member and at least one second member, wherein at least one of the members has a elongated hole for the purpose of fastening of the connecting element to the support or to a base surface by a member of fastening elements, which can be passed through the at least one elongated hole.

### PRIOR ART

For industrial installations with heavy loads such as large pipe lines, steel constructions are erected. The individual structural components of the steel structure are usually welded to each other. Welds must be created only by specialized craftsmen and are expensive to produce. Subsequent adaptation and modification of the construction are possible only under certain conditions. In areas exposed to explosion hazard, welding can be carried out only after a costly permit approval process and additional temporary structural operations.

Assembly systems for medium and heavy loads are known that comprise system supports on whose outer walls openings at predetermined spacing are arranged. A plurality of connecting element can be arranged at these openings for connecting the individual structural components to each other along the system support in a grid corresponding to the spacing of the openings.

The drawback to the known solutions is that the known system supports and the corresponding connecting parts have a high static weight and the assembly requires substantial worker expense. Moreover, in the known assembly systems one is compelled to use the predetermined grid (e.g. 50 mm). Fine adjustments are not possible in these systems; in order to make possible flexibility in the known systems, they comprise a multitude of different connecting element configured to special conditions.

### SUMMARY OF THE INVENTION

The primary object of the invention is to provide a connecting element for an assembly system that makes possible simple and flexible assembly of the supports of the assembly system that are to be connected as well as one that makes possible subsequent changes and additions to the construction created.

According to the invention, the connecting element for an assembly system is made up of a plurality of supports, in particular for an assembly system having system supports, wherein the supports have openings that are disposed in a predetermined spacing on at least one of the outer walls of the support, a first member and at least a second member, wherein at least one of the members has at least one elongated opening for the purpose of fastening the connecting element to a support or to a base surface by a member of fastening elements, which can be passed through the at least one elongated opening. At least the one member has notches over the length of the at least one elongated opening, into which the complementary notches can be brought to register.

The notches and the complementary notches engaging one another produce a form-locking connection so that a high degree of reliability against failure of the connection established using the connecting element according to the invention is produced. The complementary notches engaging in the notches of the fastening element prevents unintentional slipping of the positioned connecting element. Using the at least one elongated opening the connecting element can be moved over its length along the support, whereby the positioning and the fastening of the connecting element is substantially loosened from the notches of the openings of the support. The spacing of the individual notches provides individual, possible offset steps for the connecting element. Along with the arrangement of the connecting element according to the invention on a support, the connecting element can be mounted by one of its members on a base surface, such as a floor, a wall or ceiling of a structure and serve as the connection for the support on the base surface. Using appropriate fastening elements, the assembly of the connecting element is made possible on different base materials such as, for example, concrete, masonry, natural stone and the like. The members are angled towards each other corresponding to the three dimensional form to be created for the construction to be erected. Preferably, the connecting element comprise a low number of standard parts that principally cover the connection types that are to be used.

To be able to arrange the connecting element along the entire length of the support, the length of the at least one elongated opening corresponds at least to the sum of the spacing of the openings in the outer wall of the support and the inner diameter or the diameter of the openings. Consequently the possibility of uninterrupted displacement of the connecting element on the support along the notches are possible. In the case of high loads, the connection cross-section of only one fastening element is frequently inadequate to sustain the load via the connection. In order to increase the connection cross-section, therefore, two or more fastening element are provided. If the possibility of displacement of the connecting element on the support is not necessary a maximum of two fastening element can be arranged in the hereinbefore described embodiment of the elongated opening. For example, in order to arrange two fastening element and to be able to position the connecting element on the entire length of the support in the preferred fashion, the minimal length of the appropriate elongated opening is at least the sum of the double of the spacing of the openings in the outer wall of the support and the inner diameter or the diameter of the openings. If the possibility of displacement of the connecting element on the support is not required, a maximum of two fastening elements can be arranged in the hereinbefore described embodiment of the elongated opening.

In a preferred embodiment, all members of the connecting element according to the invention have an elongated opening. If the length of at least one member is a multiple of the predefined spacing of the openings in the support, more than one elongated opening can be provided on that member. The remaining segment of material between the elongated openings improves the strength of the member provided with two elongated openings. In order to assure the flexibility of possible applications of the connecting element according to the invention notches are provided in the zone of all elongated openings so arranged. The first member and the at least second member preferably have different lengths, which further increases the possible uses of the connecting element. If, for reasons of construction, the positioning of one connecting element at the height of the openings in the outer wall of the support is desired, one of the members has an opening instead of an elongated opening, preferably corresponding to the openings in the outer wall of the support. The opening can have a zone with notches surrounding the opening so that the complementary notches of the fastening element can engage in the notches.

Since the predefined spacing of the openings in the support is preferably of the same dimensions in all supports and the openings are arranged in all outer walls of the supports and the notches of the connecting element have notches with a predefined spacing, assembly and planning of the construction to be created is simplified. Measuring distances for the purpose of positioning the connecting element and special adaptations of the connecting element are reduced to a minimum. Adaptation with regard to planning and subsequent change of the construction is possible at any time. In addition, simple dismantling of the construction and re-use of the individual structural components is possible. If the fastening element are loosened or removed, the connecting element can be reused at another position of this or another construction.

Preferably, the second member is oriented essentially perpendicular to the first member, whereby optionally both members each have at least one elongated opening and notches over the length of the at least one elongated opening. The connecting element is configured in this embodiment as a bracket element. One member of the connecting element is, for example, arranged on a vertically oriented carrier and positioned by a number of notches at the desired height. The support to be connected to the vertically oriented support is placed on the second member and fixedly fastened. If the second member of the connecting element also has an elongated opening, assembly of the support to be connected is substantially simplified, because the component and structural tolerances can be balanced. If the zone of the elongated opening of the second member is additionally provided with notches, during the entire assembly process, the number of the complementary notches engaging in the notches, a temporary hold is made possible by the form-locking connection up to the point of fixation of the support to be connected to the vertically oriented support. Along with the advantageous assembly, the safety of all parts in the construction to be created is assured. This connecting element is particularly advantageous for construction that is being erected in a so-called frame construction. If the hereinbefore described system supports are used for erecting the construction, the connecting element can be arranged at any height and any orientation of the system supports. Optional embodiments of three-dimensional constructions are possible.

The bracket-shaped connecting element, for example, can be used as a connection of the support to a base surface as a so-called foot element for the construction, whereby preferably at least two connecting element are arranged for the purpose of affixing the support to the base surface. Each of the connecting element, for example, is provided on the opposing outer walls of the support or one each of the connecting element is provided on at least one of the outer walls of the support in the x-axis and the y-axis.

Advantageously, the second member is configured as a connection member, wherein the connection member is fabricated out of a profile section, preferably out of a hollow profile section and the connection element has openings for affixing a support by a number of fastening elements, which can be passed through the openings in the connection element. The connection element is in this embodiment configured as a substantially cantilever console. The first member is, as already described, fastened to a first support or to a base surface. If the first member is, for example, affixed to a vertically oriented support, a facial connection of the support to be connected can be created with the vertically oriented support. The length of the connection element is dependent on the loads that must be sustained. Preferably, at least two fastening elements are provided for affixing the support to be connected to the connection element. Along with the preferred fabrication of the connection using hollow profile section, the connection member can have a U-shaped configuration, wherein the members of the U-shaped connection member, for example, include a web or a flange of the support to be connected. Further, profile sections of an L-shaped section or a steel flat can be arranged as a connection member. Preferably a pair of these profile sections are provided in the x and y directions of the support to be connected on the first member of the connecting element; for example, by a weld. The configuration of the connection element is essentially dependent on the cross-sectional shape of the support to be connected and the existing loads.

Preferably, the connecting element has a third member, wherein the third member is arranged optionally in the same plane as the first member, at least one elongated opening and at least notches over the length of the at least one elongated opening, which can be brought into engagement with the complementary notches of the connecting element. The first member and the third member form the so-called base plate of the connecting element, which can be connected to a support or to a base surface. The support to be connected is fastened to the second member. With the size of the base plate and the axial spacing of the fastening element, this embodiment of the connecting element is characterized by better leverage than a two-member configuration of the connecting element. Greater moment forces can be transmitted over the connecting element to the first support or to the base surface; hence, this connecting element is particularly suited for use as a foot element in a construction. With the elongated openings in the first and second members, the fastening element passed through the elongated openings corresponding to the openings can be positioned in the first support or in a base surface. If the connecting element is, for example, arranged on a vertically oriented support, the notches provided in the zone of the elongated openings prevent any unintentional slipping of the positioned connecting element and substantially facilitate assembly. Accordingly, for example, in the third member, the fastening element having the complementary notches can be provisionally passed through the elongated opening and an opening in the support for temporary holding of the connecting element and the at least one additional fastening element, without additional support or holding of the connecting element during the setting process, passed through the elongated opening of the first member and the corresponding opening in the support.

Preferably, the external contour of the connection member is configured essentially complementary to the inside contour of the support so that the support can be slid over the connection element, whereby the support to be connected is already provisionally held at the time of this assembly step. If the support to be connected is a hollow profile section system support, the connection element has an essentially rectangular cross-section, whose external dimensions are preferably only insubstantially less than the inside dimensions of the hollow profile section system support. The fastening element is preferably stressed up to partial deformation of the support passed over the connection member, so that a form-fitting and force-fitting connection results and any play is eliminated from the connection.

In a variant according to the invention, the inside contour of the connection member is configured essentially complementary to the outside contour of the support, so that the support can be inserted into the connection member. Also in the case of this embodiment of the connection element, the support to be connected is already provisionally held at the time of this assembly step. The connection member has, for example, a rectangular cross-section, whose inner dimensions are only insubstantially larger than the outer dimensions of the support to be connected. If the support to be connected is a system support, the inner contour of the connection member can be configured complementary to the outer contour of the system support. The fastening element is preferably stressed to partial deformation of the connection member so that a form and force fitting connection results and any play is eliminated from the connection.

Preferably, the connection member has an essentially rectangular form, wherein the connection member has an x- and a y-axis relative to its center of gravity. The outer walls of the connection member oriented parallel to each other have opposing openings, so that the fastening element can be passed through the connection member and the support to be connected. Each of the outer walls of the connection member is preferably provided with openings for the purpose of fastening the support to be connected. The openings for passing through the fastening element are essentially parallel to one plane that is formed by the first member of the connecting element and have preferably a configuration that prevents twisting of the fastening element at the time of setting of the fastening element without the use of a counter holding member. If the connection member is a solid section, in lieu of a through-passing opening, a bore hole can be provided that has an inner thread for arrangement of a screw as the fastening element. Furthermore, in the case of a connection member comprised of a hollow profile section the opening, in whose outer wall can be provided with an inner thread for engaging a screw as the fastening element. The opening can also be provided with a collar, which makes possible the arrangement of an adequate number of threaded passages for securing the connection. As a variant thereof, on the inner side of the connection member comprised of a hollow profile section a nut for receiving a screw as the fastening element can be welded at the opening.

Preferably, a plurality of openings that are optionally oriented vertical to each other can be arranged in several planes running parallel to each other. In a frontal connection of a support, due to the generally existing stressing and for reasons of construction, a fastening in at least two axes is preferred. The section of the connection member therefore preferably has a length, so that at least one fastening element can be provided in the x-direction and at least one fastening element in the y-direction, each relative to the cross-section of the connection member. Using the crossed and the preferred form and force fitting connection, the support connected to the connection member is fixed in all degrees of freedom. In a variant thereof, the connection member has elongated openings in the outer walls, which simplifies the alignment of the support to be connected to the connection member, because the fastening element can be continuously positioned. A formal lock of the connection is, however, not present. The ends of the elongated openings prevent sliding down of the support connected to the connection member, if the forces acting upon the connection become too great for it.

Advantageously, the notches are arranged on the side of the member facing away from the support. The connecting element can, on sliding along the support, glide along its outer surface. A fastening element having complementary notches is passed through the opening of the connecting element and the opening or openings of the support after reaching the desired position of the connection member on the support and affixed by rigging of the fastening element. In a first variant thereof, the notches can be provided on the side of the member facing the support or the base surface. On setting the fastening element the notches are impressed into the surface of the support or the base surface and creates a form-locking connection. In a further variant, the support can preferably have the complementary notches over its entire length, into which the notches arranged on the side of the member facing the support engages and so makes possible the creation of a form-locking connection.

Preferably the notches include a toothing, wherein the distribution of the teeth of the toothing is preferably 2.5 mm. With this distribution individual notch steps are 2.5 mm or a multiple thereof is possible. This configuration of the notches covers a large part of the demands on the configuration of the assembly system occurring in practice. The toothing is preferably matched to the desired offset notches and the existing load effects. Accordingly, for example, there is the required number of teeth of the toothing of the notches and complementary notches, the geometry, the width and the depth of the arranged toothing. If, for example, a finer stepping of the notches comprised of the notches and complementary notches is desired, the tooth spacing of the notches formed by the notches and complementary notches as desired can be reduced. In the case of greater loads, the tooth spacing of the notches and the complementary notches, for example are also configured larger and with a deeper configuration of the teeth. For example, it is an arrangement of notches having a so-called prism toothing. Other possibilities for configuring the notches represent serrated pins or spaced recesses on a member such as, for example, grooves and the like.

Preferably the connection element has at least one bead. Using the bead, maximum stiffness of the connecting element is obtained while using a minimum of material. In other words, at a specific material thickness of the member a greater load can be sustained by it than in the case of a flat configuration of the member, for example.

Advantageously, the toothing is arranged in at least one of the bead walls of the at least one bead. The toothing can be rolled or embossed onto the rib wall. Through this working process the material of the connecting element is thickened in the zone of the toothing, which results in an increase in strength. For engagement of the complementary notches and for the creation of a form-locking connection, the available surface of the bead wall is normally sufficient, so that a secure fastening of the connecting element and the supports connected by these connecting elements is possible.

In a variant thereto according to the invention an area surrounding the at least one elongated opening has notches. Using this configuration of the connecting element a large engagement surface of the complementary notches into the notches are made possible. A connecting element configured in this fashion is suitable for use in construction in the heavy load range.

Preferably, the notches run parallel to each other, transverse to the at least one elongated opening. If the connecting element, for example, is arranged on a vertically oriented support, the loading is transverse to the orientation of the notches. In particular in the case of a combination of teeth transverse to the direction of the force and teeth disposed on the side facing away from the support and a wrap-around geometry communicating with the notches, the result is a secure, form-locking connection that makes possible a finely graded positioning of the connecting element on the carrier.

Advantageously, the outer contour at least of one member is complementary to the outer contour at least of one of the supports that can be connected with the connecting element. System supports of an assembly system frequently have contoured outer surfaces. Despite a minimal material thickness, high loads can be sustained by the connecting element. The member configured complementary to the outer contour also abuts flatly on the outer contour of the system support. At the time of assembly of the connecting element to the first support, there is a guiding by the interlocking configuration of the two element, which facilitates assembly.

Preferably the fastening element for fastening the connecting element to a support comprises a screw having a rear grip member, wherein the rear grip member has complementary notches and wherein the complementary notches comprehend an arrangement of teeth. The rear grip member is, for example, a separate metal plate, that has complementary notches corresponding to the complementary notches. The rear grip member can furthermore be a washer or a screw head, at which the complementary notches are directly formed. Preferably the rear grip part is non-rotationally engaged with the screw or is fixedly connected to same, for example, so as to be incapable of loosening. Through the interlocking of the notches with the complementary locking arrangement the screw means is held securely non-rotatingly when it is checked for guiding the screw at the time of setting same. For the purpose of guiding the screw at the time of setting in the openings of the connecting element and the supports held by the connecting element, guide surfaces can be provided on the screw. For example, if the openings in the supports are configured as square openings, the screw therefore has preferably planar surfaces that are matched to these square holes in the supports. The width of the elongated holes provided on the connecting element corresponds in the case of this embodiment preferably to the inside width of the square openings.

Preferably the fastening element comprises a spring-biased pressure mechanism for tensioning the fastening element with the connecting element. A spring element is preferably disposed between a nut and the side of the support at the screw, which lies opposite the support side at which the connecting element is arranged. The spring element is, for example, a helical spring, a flat spring, a conical or wound spring or the like. The spring element is provided on the part of the fastening element that is passed though the opening of the support, prior to the arranging of the nut for tensioning the fastening element on the support. Prior to final fixation of the connecting element arranged on the support, by pressure on the nut, the element configured as a rear grip part and using the width the complementary notches can be lifted from the notches of the connecting element. With a single-handed movement the connecting element can be repositioned. By loosening the nut of the fastening element the complementary notches engages in the notches and the connecting element is held on the support. The fastening element can, in a variant thereto, be configured like a so-called rapid tension adjusting nut, which can be introduced into corresponding openings in the connecting element or into the support. Rapid tension adjusting nuts of this type are, for example, configured like rapid tension adjusting nuts of installation systems for pipe fittings to C-shaped assembly bars.

In the following more detailed description and the set of Patent Claims further advantageous embodiments and combinations of features of the invention are provided.

### BRIEF DESCRIPTION OF THE DRAWINGS

In the following, the invention will be explained in greater detail; wherein:

FIG. 1 represents a perspective view of a first exemplary embodiment of a connecting element according to the invention;

FIG. 2 represents a perspective view of a second exemplary embodiment of a connecting element according to the invention;

FIG. 3 represents a top view of a third exemplary embodiment of a connecting element according to the invention;

FIG. 3a represents a detailed view of a part of FIG. 3;

FIG. 4 represents a side view of the connecting element illustrated pursuant to the third exemplary embodiment;

FIG. 5 represents a longitudinal section of the connecting element pursuant to the third exemplary embodiment along the line of section V-V of FIG. 3;

FIG. 6 represents a top view of a fourth exemplary embodiment of a connecting element according to the invention;

FIG. 7 represents a view of a fastening element, and

FIG. 8 represents a view of a rear grip part of the fastening element.

In principle, identical parts are identified using identical references in the drawings.

### DETAILED DESCRIPTION OF THE INVENTION

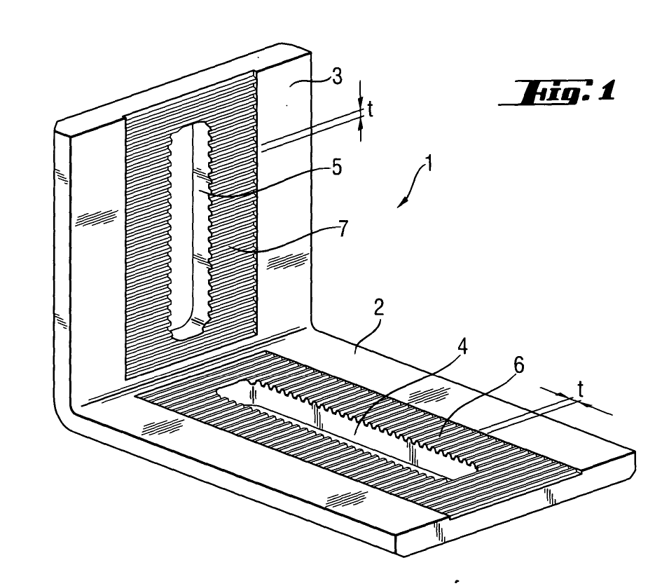

FIG. 1 represents a perspective view of a first exemplary embodiment of a connecting element according to the invention. The bracket element 1 is configured having uneven leg members and comprises a first member 2 and a second member 3, wherein the first member 2 has a length that is longer than the length of the second member 3. The bracket element is, for example, made from a steel flat or sheet as a punch/bend part. An elongated opening is arranged in the first member 2, whose minimal length corresponds to the sum of the length from the double of the spacing of the openings in the support to which the first member 2 is arranged and the inside diameter of the opening of the support. Preferably, in the described support it is a system support for an assembly system. The supports have, for example, openings in the form of a square hole with an inside diameter of 13.5 mm and a grid spacing of the openings of 50.0 mm. The length of the elongated opening 4 is, relative to the aforementioned conditions, approximately 115.0 mm, wherein two fastening element can be arranged in the elongated opening 4.

An elongated opening is provided also in the second member 3, whose minimal length corresponds to the sum of the length from the spacing of the openings in the support on which the second member 3 is arranged and the inside diameter of the opening of the support. Preferably, everywhere the same type of support is used with the construction to be created. As a result, a lower number of different components will be required for the construction to be erected, which will have favorable results on warehousing and assembly. The length of the elongated opening 5 is approximately 65.0 mm under the aforementioned conditions, wherein a fastening element can be arranged in the elongated opening 5. The width of the bracket element 1 preferably corresponds at most to the width of the outer wall of the support on which the bracket element 1 is arranged. If the support has different dimensions in cross-section, for example, two bracket element with different widths adapted to the dimensions of the support cross-section will be provided or width at the outer wall with the larger dimension a bracket element having a width, which corresponds to the shorter dimension of the support cross-section will be provided.

At the surface areas surrounding the elongated hole 4 and the elongated hole 5, the notches 6 or 7 are formed, in which the complementary notches of a fastening element can be brought into engagement. The bracket element 1 is, for example, used for a rectangular connection of a vertically and a horizontally oriented support. Since the loading in such an application of the bracket element 1 is generally greater in the vertical sense than in the horizontal sense of the construction, the first member 2 is preferably arranged on the vertically oriented support, whereby two fastening element for affixing the bracket element 1 to the support can be arranged. The increased connection cross-section as compared to only one fastening element allows bearing of higher loads.

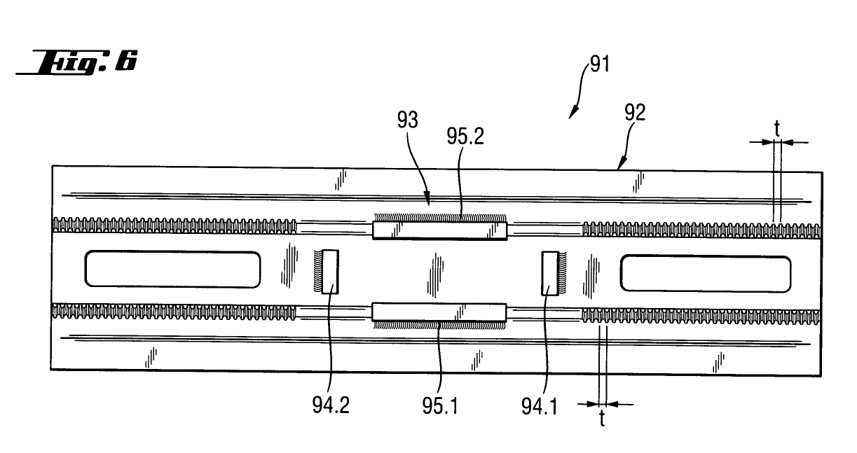

For fastening the bracket element 1 to the vertically oriented support, the bracket element 1 is roughly positioned on the outer wall of the support at the height, at which the other support connects. A first fastening element provided with complementary notches is passed through the elongated opening 4 and through the openings on the outsides of the support. A possible embodiment of a fastening element is described in detail in FIG. 6. Before final checking of the fastening element the bracket element 1 is aligned at the exact height and the second fastening element is passed in the same fashion through the elongated opening 4 and through the openings in the outer wall of the support, which are adjacent to the openings in the outer wall of the support having the first fastening element. The support abutting on the second member 3 of the bracket element is fastened to the bracket element 1 after its alignment using an additional fastening element, which is passed through the elongated opening 5 and through the openings in the outer walls of the support.

The notches are, for example, configured as prism teeth and have in this exemplary embodiment a tooth pitch t of 2.5 mm. With the combination of openings configured as elongated openings 4 and 5 in the bracket element and the notches and complementary notches that can be brought into engagement with each other, the bracket element 1 can be stepwise displaced in a grid of, for example, 5.0 mm along the support, although the support has a grid spacing of the openings of 50.0 mm. This illustration covers the constructions usually erected in practice.

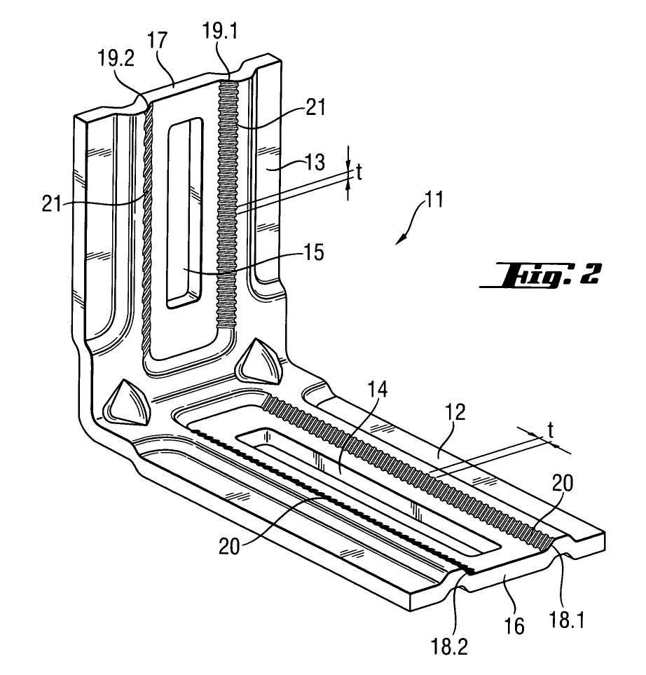

FIG. 2 represents a perspective view of a second exemplary embodiment of a connecting element according to the invention. The bracket element 11 is, similar to the bracket element 1, configured with unequal members and comprises a first member 12 and a second member 13. The bracket element 11 is likewise used in the connection of two system supports of an assembly system, which has the hereinbefore described arrangement of the openings in their outer walls. The length of the elongated opening 14 in the first member 12 accordingly is approximately 115.0 mm. The length of the elongated opening 15 in the second member 13 is approximately 65.0 mm. A bead 16 is formed on the first member 12 and as is a bead 17 on the second member 13. The system support, for example, has recesses on its outer walls. The beads 16 and 17 are preferably complementary to the recesses in the outer walls of the support so that the bracket element 11 fastened to the supports makes contact entirely on the surface of an outside of the support. The notches 20 and 21 are formed by rolling on the bead walls 18.1 and 18.2 and on bead walls 19.1 and 19.2. The complementary notches engage in the notches 20 and 21 of the fastening elements.

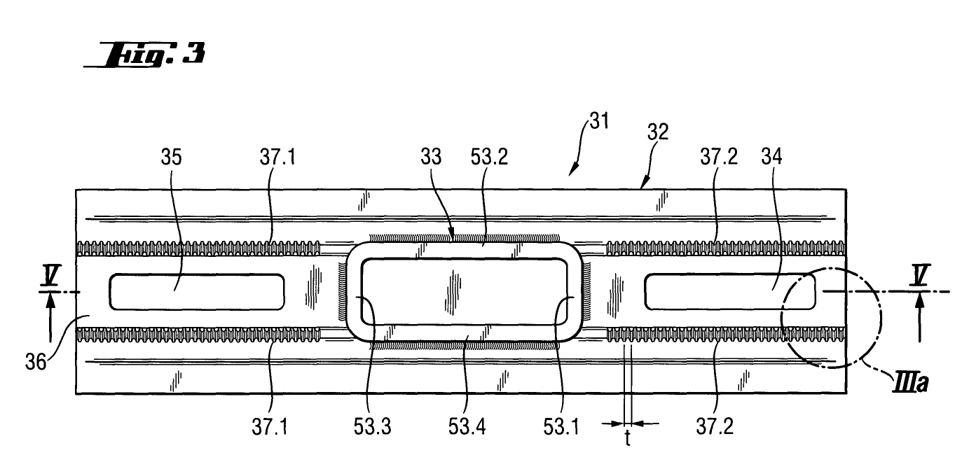

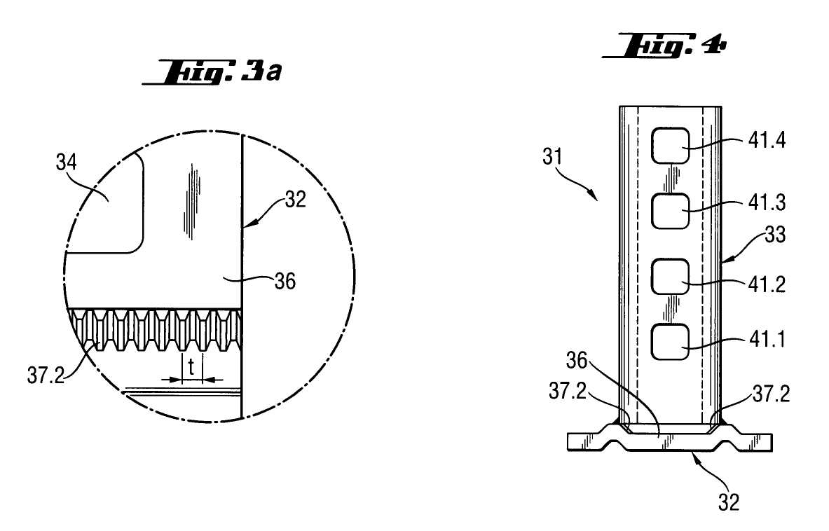

A top view of a third exemplary embodiment of a connecting element according to the invention is represented in FIG. 3. The front attachment member 31 comprises a base plate 32 and a connection member 33. The support to be connected to the front attachment member 31 is pushed over the connection member 33 and affixed thereto using a fastening element. The outer contour of the connection member 33 is essentially complementary to the inner contour of the support to be connected. The base plate 32 has two elongated openings 34 and 35 for fastening the front attachment member 31 to a hereinbefore described system support, wherein for the arrangement of two fastening element in each elongated opening 34 and 35 their lengths, similar to the aforementioned, are approximately 115.0 mm. The connection member 33 is welded between the elongated openings 34 and 35 on the base plate 32. A bead 36 is formed on the base plate 32 over its entire length and is preferably complementary to at least one of the outer contours of the support on which the front attachment member 31 is arranged. The notches 37.1 and 37.2 of the front attachment member 31 are formed on the walls of the bead. Should the front attachment member 31 be used as a foot element in a construction, for example for arrangement on a concrete floor, the formation of the bead 36 in the base plate 32 will be omitted, so that the front attachment member lies flat on the concrete floor.

FIG. 3a represents a detail cut-out IlIa of FIG. 3. The notches 37.2 formed on the bead wall of bead 36 has a tooth pitch t of 2.5 mm, which together with the complementary notches of the fastening element makes possible a grid setting of the front attachment member 31 of 2.5 mm or a multiple thereof.

FIG. 4 represents a side view of the connecting element according to the third exemplary embodiment. A plurality of openings 41.1 to 41.4 are provided in the connection member 33, through which openings the fastening element is passed for affixing the connection member 33 to the support to be connected. The openings 41.1 to 41.2 are configured as square holes and have the same inside diameter as the openings in the supports. The spacing of the openings 41.1 to 41.4 is 25.0 mm, which corresponds to the half of the spacing of the openings in the outer walls of the support. Since the support has on its outer wall openings with a spacing of 50 mm arranged offset to each other, the fastening element passed through the openings in the x and y directions of the support cannot obstruct each other. If, in the case of each opening 41.1 to 41.4 in the connection member 33, there should be a passage of fastening element in the x and y directions of the support, the support can be provided with additional openings in its outer walls corresponding to the spacing of the openings 41.1 to 41.4.

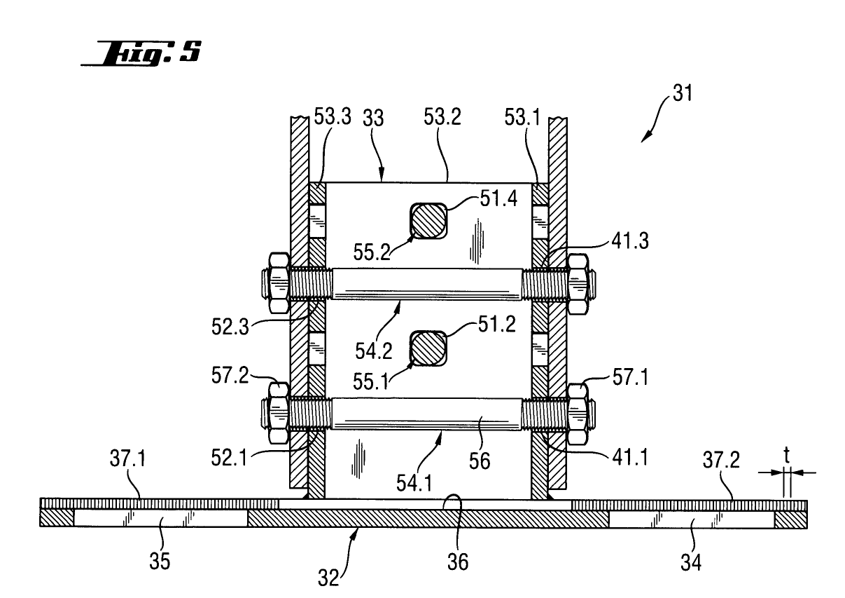

FIG. 5 represents a longitudinal section of the connecting element according to the third exemplary embodiment along the line of section V-V of FIG. 3. The connection member 33 has openings on all four outside walls 53.1 to 53.4 (e.g. 41.1, 41.3; 51.2, 51.4; 52.1, 52.3). In openings 41.1 and 52.1 or 41.3 and 52.3 the fastening element 54.1 and 54.2 are arranged in the x-direction of the connection member 33. In openings 51.2 and 51.4 and in those (not shown in this representation) arranged in the outer walls 53.4 and the fastening element 55.1 and 55.2 are provided in the y-direction of the connection member 33. The fastening element 54.1 comprises a threaded pin 56, at whose ends a nut 57.1 and 57.2, respectively, is arranged for tensioning the fastening element 54.1. The fastening element 54.1, 54.2, 55.1, 55.2 are configured identically in this exemplary embodiment. With the crossed arrangement of the fastening element 54.1, 54.2, 55.1 and 55.2 a form-locking and force-locking, advantageous connection is created for the supports to be connected with the front attachment member 31.

A top view of a fourth exemplary embodiment of a connecting element according to the invention is represented in FIG. 6. A front attachment member 91 comprises a base plate 92, which is configured essentially like the base plate 32 of the front attachment means 31, note FIG. 3, and a connection member 93. The support to be connected to the front attachment means 91 is pushed over the connection member 92 and affixed to it using fastening element. The connection member 93 comprises four connection flanges 94.1, 94.2, 95.1 and 95.2, which are fabricated from steel flat sections. Each of the opposing connection flanges 94.1 and 94.2 or 95.1 and 95.2 are of identical configuration. The outer contour of the connection member 93 is essentially complementary to the inner contour of the support to be connected. The connection flanges 94.1, 94.2, 95.1 and 95.2 of the connection member 93 are welded between the elongated openings in the base plate 92. As in the connection member 33, a plurality of openings are provided in the connection flanges 94.1, 94.2, 95.1 and 95.2 of the connection member 93 and the fastening element for affixing the support to be connected to the connection member 93 are passed through the openings.

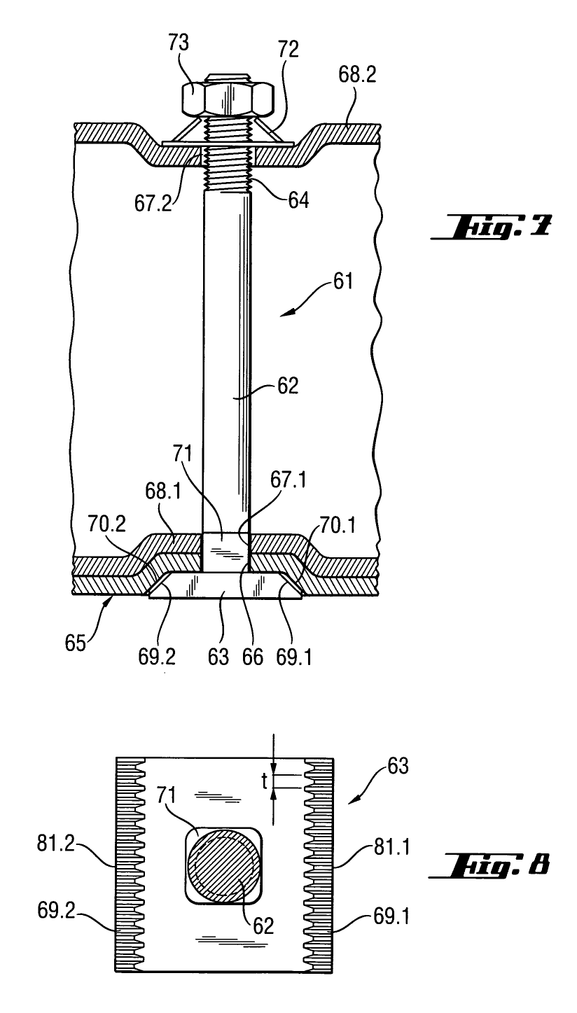

FIG. 7 represents a view of a fastening element. The fastening element 61 comprises an elongated screw 62, on the one end of which a rear grip part 63 is formed and which has on its other end a threaded segment 64. The fastening element 61 is passed through this elongated opening 66 and the opening 67.1 in the outer wall 68.1 of the support as well as through the opening 67.2 in the outer wall 68.1 of the support for the purpose of fastening a connection element 65. The complementary notches 69.1 and 69.2 arranged on the rear grip part 63 engage in the notches 70.1 or 70.2 arranged on the connecting element 65 and create a form locking connection. The screw 62 has a guide segment 71 complementary to the form of the opening 67.1 as rotational security and for guiding the fastening element 61.

A spring element 72 comprising a flat spring is set on the threaded segment 64 of the screw 62 and a nut 73 screwed thereon. The spring element 72 is configured so that, for example, it can be arranged in a depression in the contoured outer surface of the outer wall 68.2. Should the fine positioning of the connecting element 65 occur, the rear grip part is lifted out of the form locking connection with the connecting element by pressure on the nut 73 and the connecting element can then be moved with the hand. If the nut 73 is released, the complementary notches 69.1 and 69.2 engage in the notches 70.1 or 70.2 and re-establish the form-locking connection. The connecting element 65 is held in its position. If this position is in accord with the desired position of the connecting element 65, the fastening element is tensioned with the nut 73 and the connecting element 65 is affixed on the outer wall 68.1 of the support.

A view the rear grip part 63 of the fastening element is represented in FIG. 8. The rear grip part 63 has a rectangular configuration and is fixedly attached to one end of the screw 62. At two margins or sides 81.1 and 81.2 running parallel to each other the complementary notches 69.1 and 69.2 are formed, which engage in the notches of the connecting element.

In summary, it must be noted that a connecting element for an assembly system has been created that makes possible simple and flexible assembly of the supports of the assembly system that are to be connected as well as enables subsequent changes and expansions to the construction erected. A multitude of constructions whose erection was previously costly can now be erected with few, standardized individual parts. The majority of connections can be done by a single-worker assembler with high assembly comfort and the use of special tools or machines is eliminated.

1. A connecting element for an assembly system comprising a plurality of supports, such as an assembly system having system supports, wherein the supports have openings arranged in a defined spacing on at least one of the outer walls (68.1, 68.2) of the support, said connecting element (1; 11; 31; 65) comprises a first member (2; 12; 32) and at least one second member (3: 13; 33) with at least one of said first and second members (2; 12; 32;3; 13; 33) having at least one elongated opening (4, 5; 14, 15, 34, 35, 66) with at least notches over the length of said at least one elongated opening for securing said connecting element (1; 11; 31;65) to a support or to a base surface by a fastening element (61), passed through the at least one elongated opening (4, 5; 14, 15,34, 35; 66), engageable with complementary notches (69.1, 69.2) of a fastening element (61).

2. A onnecting element, as set forth in claim 1, wherein said second member (3; 13; 33) is arranged essentially perpendicular to said first member (2: 12; 32) and at least one of said first and second members (2, 3; 12, 13; 32, 33) have at least one said elongated opening (4, 5; 14, 15; 34, 35) and at least said notches (6, 7; 20, 21; 37.1, 37.2) over the length of said at least one elongated opening (4, 5; 14, 15; 34, 35).

3. A connecting element, as set forth in claim 1, wherein said second member (33) is a connector (33) formed of a profile section with openings (41.1 to 41.4; 51.2, 51.4; 52.1, 52.3) for fixing the support by fastening elements passable through said openings (41.1 to 41.4; 51.2, 51.4; 52.1, 52.3) in said connector (33).

4. A connecting element as set forth in claim 3, wherein said connector (33) comprises a third member (32), and said third member has at least one elongated opening (34, 35) with notches (37.1, 37.2) located along the length of said at least one elongated opening (34, 35) for engagement with complementary notches of a fastening element.

5. A connecting element, as set forth in claim 3, wherein an outer contour of said connector (33) is formed complementary to an inner contour of said support so that said support can slide over said connector (33).

6. A connecting element, as set forth in claim 3, wherein an inner contour of the connector (33) is shaped complementatry to an outer contour of the support so that the support can be inserted into said connector (33).

7. A connecting element, as set forth in claim 3, wherein said connector (33) has a rectangular configuration and the openings (41.1 to 41.4; 51.2, 51.4; 52.1, 52.3) are arranged parallel to a plane for the passage of a fastening element, with said plane formed through said first member (32) of the connecting element.

8. A connecting element, as set forth in claim 7, wherein a plurality of openings (41.1 to 41.4; 51.2, 51.4; 52.1; 52.3) are arranged vertically relative to each other in a plurality of planes parallel to each other.

9. A connecting element, as set forth in claim 1, wherein the notches (6, 7; 20, 21; 37.1, 37.2) are arranged on the side of said first and second members facing away from said support.

10. A connecting element, as set forth in claim 1, wherein said notches (6, 7; 20, 21; 37.1, 37.2; 70.1, 70./2) comprise teeth.

11. A connecting element, as set forth in claim 1, wherein said connecting element (11; 31; 65) has at least one bead (16; 17; 36) extending in the elongated direction of said openings (4, 5, 14, 15, 34, 35).

12. A connecting element, as set forth in claim 11, wherein said teeth are arranged in a least one said bead walls of said at least one bead (16, 17, 36).

13. A connecting element, as set forth in claim 1, wherein a surface zone surrounding at least one said elongated opening has notches (6, 7).

14. A connecting element, as set forth in claim 13, wherein the notches (6, 7) extend parallel to one another transversely of the length of said at least one elongated opening (4, 5; 14, 15; 34, 35; 66).

15. A connecting element, as set forth in claim 1, wherein the outer contour of said at least one member (2, 3) is complementary to the outer contour of at least one of the supports capable of being connected with said connecting element (1;11; 31).

16. A connecting element, as set forth in claim 1, wherein a fastening element (61) for securing a connecting element (65) to a support comprises an elongated screw having a threaded first end segment (64) and an opposite end rear grip part (63), with compelementary notches (69.1, 69.2) comprising teeth.

17. A connecting element, as set forth in claim 16, wherein said fastening element (61) comprises a spring-biased pressure mechanism for tensioning said fastening element (61) with said connecting element (65).

18. A connecting element, as set forth in claim 2, wherein both said first and second members (2, 3) have at least one said elongated opening (4, 5).

19. A connecting element, as set forth in claim 3, wherein said second member is formed of a hollow section.

20. A connecting element, as set forth in claim 4, wherein said third member (32) is arranged in the same plane as said first member.

21. A connecting element, as set forth in claim 10, wherein the pitch of said teeth is 2.5 mm.
